(19) United States
(12) Patent Application Publication
(10) Pub. No.: US 2013/0031426 A1
(43) Pub. Date: Jan. 31, 2013

(54) COMMUNICATION APPARATUS

(71) Applicant: Hidetaka Kan, Chiyoda-ku (JP)

(72) Inventor: Hidetaka Kan, Chiyoda-ku (JP)

(73) Assignee: MITSUBISHI ELECTRIC CORPORATION, Chiyoda-ku, TOKYO (JP)

(21) Appl. No.: 13/500,454

(22) PCT Filed: Jul. 28, 2011
(86) PCT No.: PCT/JP2011/067322

§ 371 Date: Apr. 5, 2012

(51) Int. Cl. G06F 11/07

(52) U.S. Cl. 714/48; 714/E11.024

(57) ABSTRACT

To make it possible to easily identify the error location, a communication apparatus includes: a first storage unit; an error detecting unit detecting a bus error caused on a bus of its own PLC; an error counting unit counting the number of times the error detecting unit has detected a bus error and recording a counted value of the bus error in the first storage unit; a transmitting unit transmitting a counted value recorded in the first storage unit and counted by the error counting unit to all of other PLCs belonging to the same PLC system; and a receiving unit receiving a counted value transmitted from the other PLCs belonging to the same PLC system and storing the received counted value in the first storage unit in such a way that a PLC that is a transmission source of the counted value can be identified.

### FIELD

The present invention relates to a communication apparatus that is incorporated in a programmable logic controller (PLC) and network-connects PLCs.

### BACKGROUND

There is a type of PLC that is configured to have one or more functional units connected to a base unit. A CPU unit that performs general control of PLCs, an input/output unit that performs inputting and outputting between controlled devices, a network unit serving as a communication apparatus that performs communications to other PLCs, etc. are provided for the functional units, and a user can configure PLCs by combining desired functional units. The base unit has a bus incorporated therein, and a plurality of functional units fitted to the base unit can transmit/receive data to/from each other via the bus.

In addition, there is a case where distributed control of an FA system is performed using a plurality of PLCs. Each of these PLCs is fitted with a network unit, and performs control of the FA system in cooperation of the other PLCs by transmitting/receiving control data to/from each other via the network unit.

In this case, in each of the PLCs, an access error (hereinafter, referred to as “bus error”) sometimes occurs between the CPU unit and an other functional unit. Error information describing a content of the bus error is recorded in a storage unit that is included in the CPU unit fitted in a PLC in which the bus error has occurred.

As disclosed in Patent Literature 1, there is also a type of PLC that can store information necessary to analyze bus errors or the like, in an FA link module.

Furthermore, as a technique of remotely monitoring bus errors, as a publicly known technique, there is an information processing apparatus that can transmit error information of bus errors to a remote monitoring apparatus (see Patent Literature 2, Patent Literature 3, and Patent Literature 4).

### CITATION LIST

### Patent Literatures

Patent Literature 1: Japanese Patent Application Laid-open No. H06-110858
Patent Literature 2: Japanese Patent Application Laid-open No. H10-247167
Patent Literature 3: Japanese Patent Application Laid-open No. H05-053934
Patent Literature 4: International Publication No. WO 00/51000

### SUMMARY

### Technical Problem

However, as described in Patent Literature 1, in the case where a network unit is configured to retain error information of its own PLC or record error information of its own PLC in a storage unit of a CPU unit, when a bus error occurs, a user has to check each of the PLCs one by one so as to acquire the corresponding error information, and therefore considerable time and labor are required for clarifying the cause of the bus error.

Furthermore, in the case where the technique disclosed in Patent Literatures 2 to 4 is applied to a PLC system, when a bus error occurs, a user has to check each of the remote monitoring apparatuses for every network unit one by one, and therefore considerable time and labor are also required for analyzing the bus error.

The present invention has been achieved in view of the above problems, and an object of the present invention is to provide a communication apparatus that can identify the location where a bus error has occurred, in a simple manner.

### Solution to Problem

In order to solve the above-mentioned problems and achieve the object, the present invention provides a communication apparatus that is connected to a bus, constitutes a programmable logic controller (PLC) together with the bus, and network-connects its own PLC to other PLCs, so as to establish a PLC system, the communication apparatus comprising: a first storage unit; an error detecting unit that detects a bus error caused on a bus of its own PLC; an error counting unit that counts the number of times the error detecting unit has detected an bus error and records a counted value of a bus error in the first storage unit; a transmitting unit that transmits a counted value that is recorded in the first storage unit, and counted by the error counting unit to all of other PLCs belonging to the same PLC system; and a receiving unit that receives a counted value transmitted from the other PLCs belonging to the same PLC system and stores the received counted value in the first storage unit in such a way that a PLC that is a transmission source of the counted value can be identified.

### Advantageous Effects of Invention

The communication apparatus according to the present invention can check bus errors in all of PLCs constituting a PLC system by checking an arbitrary one among the PLCs constituting the PLC system, and therefore a location where a bus error has occurred can be identified in a simple manner.

### BRIEF DESCRIPTION OF DRAWINGS

FIG. 1 is a diagram showing a configuration of a PLC system configured with a network unit according to a first embodiment.

FIG. 2 is a diagram showing an internal configuration of the network unit according to the first embodiment.

FIG. 3 is a diagram illustrating an operation of the PLC system according to the first embodiment.

FIG. 4 is a flowchart for describing an operation of the network unit according to the first embodiment, included in a PLC at side of transmitting error information.

FIG. 5 is a flowchart for describing an operation of the network unit according to the first embodiment, included in a PLC at a side of receiving error information.

FIG. 6 is a diagram showing a configuration of a PLC system configured with a communication apparatus according to a second embodiment.

FIG. 7 is a diagram showing an internal configuration of a functional unit according to the second embodiment.

FIG. 8 is a diagram illustrating an internal configuration of a network unit according to the second embodiment.

### DESCRIPTION OF EMBODIMENTS

Embodiments of a communication apparatus and a PLC according to the present invention will be described below in detail with reference to the accompanying drawings. The present invention is not limited to the embodiments.

### First Embodiment

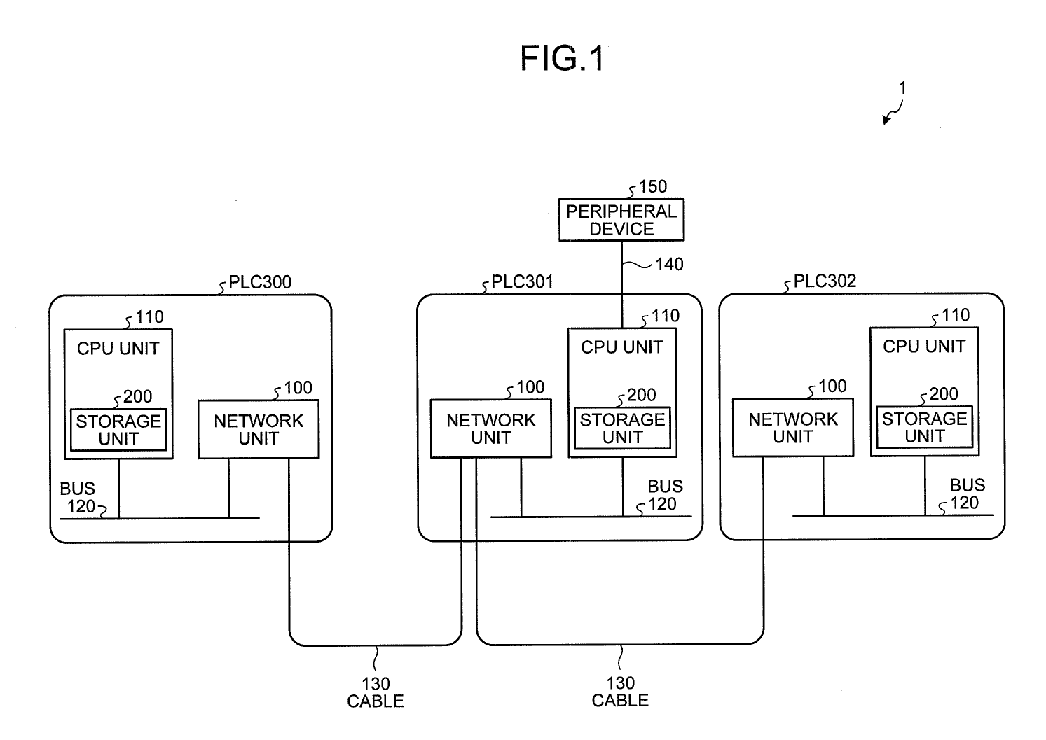

FIG. 1 is a diagram showing a configuration of a PLC system configured with a network unit to which a communication apparatus according to a first embodiment of the present invention is applied. As shown in FIG. 1, a PLC system 1 is configured with a plurality of PLCs (in this example, three PLCs, that are a PLC 300, a PLC 301 and a PLC 302) connected by cables 130 in a daisy chain mode. The PLC 300, the PLC 301 and the PLC 302 can transmit/receive data to/from each other in a communication system in compliance with a token passing system. While it is assumed that the PLC system 1 includes a line-shaped network topology, adoptable network topology is not limited to a line-shaped one. For example, it can be star shaped or ring shaped.

The PLCs 300 to 302 have mutually the same configuration, except for the PLC 301 being connected to a peripheral device 150. Therefore, the configuration of the PLC 300 is described serving as a representative of the PLCs 300 to 302.

The PLC 300 includes a network unit 100 that performs communications between the PLC 300 and other PLCs via the cable 130, a CPU unit 110 that performs control of the entire PLC 300, and a bus 120 that electrically connects the network unit 100 and the CPU unit 110. Various functional units other than the network unit 100 can be also connected to the bus 120. Functional units connected to the bus 120 are controlled by the CPU unit 110.

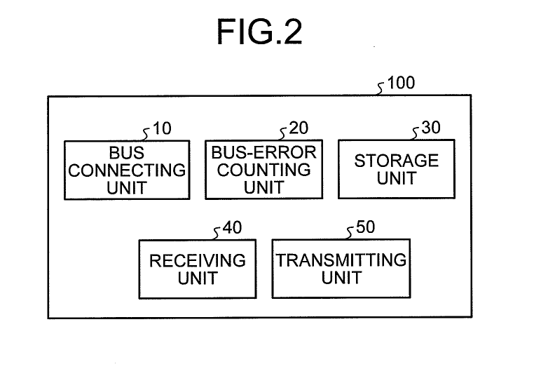

FIG. 2 is a diagram showing an internal configuration of the network unit 100. As shown in FIG. 2, the network unit 100 includes: a bus connecting unit 10 that transmits/receives data to/from the CPU unit 110 that is connected to the same bus 120 and detects a bus error caused on the bus 120; a bus-error counting unit 20 that counts the number of detected bus errors, a storage unit (first storage unit) 30 that stores therein the counted value of bus errors as error information related to its own PLC 300; a receiving unit 40 that receives frames transmitted from PLCs other than the PLC 300 via the cable 130; and a transmitting unit 50 that transmits error information related to its own PLC 300 stored in the storage unit 30 via the cable 130 to all of the other PLCs belonging to the same PLC system 1 as transmitting destinations.

The receiving unit 40 receives error information transmitted from PLCs other than the PLC 300 and records the received error information related to the other PLCs in the storage unit 30. That is, not only error information related to its own PLC but also error information related to the other PLCs is recorded in the storage unit 30. It is assumed that each error information piece stored in the storage unit 30 can be identified as to which PLC the error information piece is related to. For example, PLC identification information may be attached to an error information piece. The attachment of the identification information may be done, for example, by the receiving unit 40, or by the bus-error counting unit 20 belonging to a PLC that has generated the error information.

The CPU unit 110 includes a storage unit (second storage unit) 200 that is constituted by a rewritable storage device.

The bus connecting unit 10 transfers error information for each PLC stored in the storage unit 30 via the bus 120 to the storage unit 200 included in the CPU unit 110. In this case, there is employed a method in which the bus connecting unit 10 causes the CPU unit 110 to read error information for each PLC from the storage unit 30 and then issues to the CPU unit 110 a signal for instructing the storage unit 200 to store therein the read error information.

The peripheral device 150 is connected to the CPU unit 110 included in the PLC 301, via a cable 140. The peripheral device 150 is a tool that is realized by executing a predetermined program on a personal computer, and is capable of performing setting of the CPU unit 110 that is a connecting destination of the device. In this case, the peripheral device 150 can refer to the storage unit 200 included in the CPU unit 110. That is, a user can check bus errors caused in all of the PLCs 300 to 302 by connecting the peripheral device 150 to the CPU unit 110 included in an arbitrary PLC among the PLCs 300 to 302 and referring to error information recorded in the storage unit 200 of the CPU unit 110 that is a connecting destination of the device.

A part or all of the bus connecting unit 10, the bus-error counting unit 20, the receiving unit 40 and the transmitting unit 50 that are included in the network unit 100 may be realized as either one of hardware and software, or as a combination thereof. Realization as software means that, in a computer having an arithmetic device and a storage device, program modules corresponding to constituent elements are stored in the storage device and the program modules stored in the storage device are executed by the arithmetic device, thereby realizing functions of the constituent elements. The storage unit 30 is constituted by a rewritable storage device.

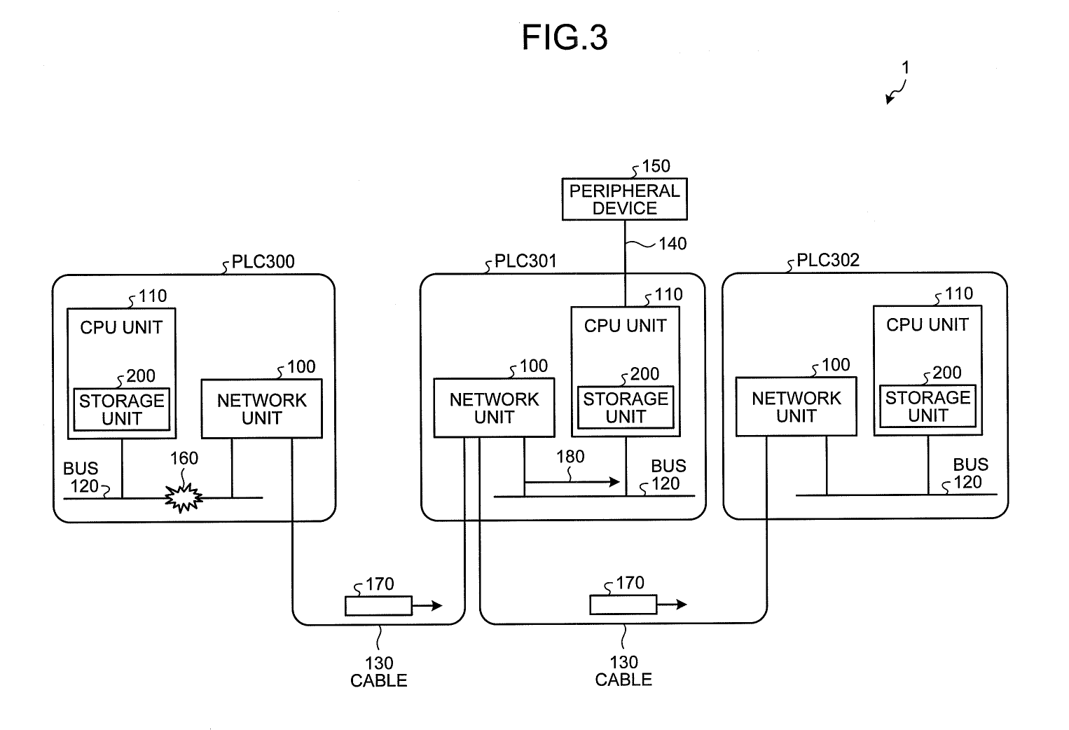

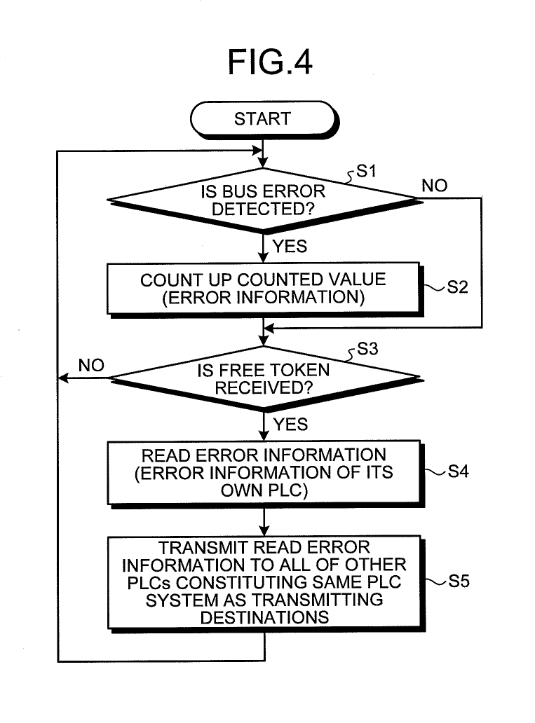

An operation of the PLC system 1 according to the first embodiment is described next. An operation of the PLC system 1 at the time of transmitting error information is described first with reference to FIGS. 3 and 4. FIG. 3 is an explanatory diagram of an operation of the PLC system 1, and FIG. 4 is a flowchart for describing an operation of the network unit 100 included in a PLC at a side of transmitting error information. In this example, description is made on the presumption that the PLC 300 is a PLC at a side of transmitting error information, and the PLC 301 is a PLC at a side of receiving the error information.

In the network unit 100 included in the PLC 300, the bus connecting unit 10 monitors the bus 120, and determines whether or not any bus error is detected (Step S1). When an access error 160 is caused by electric noises or vibrations, for example, in a bus-access between the CPU unit 110 and the network unit 100 of the PLC 300, the bus connecting unit 10 can detect a bus error by reading the location related to the error from a signal on the bus 120.

When a bus error is detected (YES at Step S1), the bus-error counting unit 20 counts up a counted value stored as error information in the storage unit 30 (Step S2). When any bus error is not detected (NO at Step S1), the process of Step S2 is skipped.

Meanwhile, the receiving unit 40 determines whether or not any free token is received (Step S3). When any free token is not received (NO at Step S3), the process at Step S1 is performed.

When a free token is received (YES at Step S3), the transmitting unit 50 reads error information related to its own PLC 300 stored in the storage unit 30 (Step S4), and then transmits a frame 170 including the read error information to all of the other PLCs 301 and 302 as transmitting destinations via the cable 130 (Step S5). The network unit 100 of the PLC 300 performs the process of Step S1 after performing the process of Step S5.

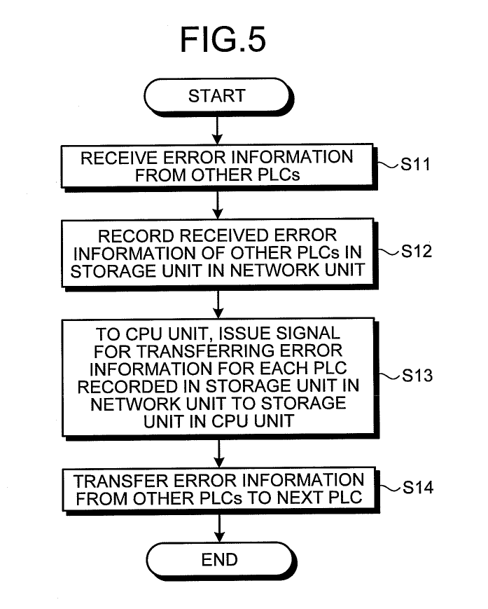

An operation of the PLC system 1 at the time of receiving error information is described next with reference to FIGS. 3 and 5. FIG. 5 is a flowchart for describing an operation of the network unit 100 included in the PLC 301 at a side of receiving error information.

Because the PLCs 300 to 302 are connected to each other in a daisy chain mode, the PLC that receives first a frame transmitted by one of these PLCs is determined in advance. In this example, a frame transmitted by the PLC 300 is received first by the PLC 301. In the network unit 100 included in the PLC 301, when the receiving unit 40 has received the frame 170 including error information of the PLC 300 (Step S11), the receiving unit 40 reads bus error information of the PLC 300 from the frame 170, and stores the read error information in the storage unit 30 (Step S12). Then, the bus connecting unit 10 generates a signal 180 to read error information for each PLC stored in the storage unit 30 and to store the read error information for each PLC in the storage unit 200, and transmits the signal 180 to the CPU unit 110 of the PLC unit 301 (Step S13). Following to this, the transmitting unit 50 transmits the frame 170 received by the receiving unit 40 to the PLC 302 (Step S14), and the operation is finished.

Upon reception of the signal 180, the CPU unit 110 reads the error information for each PLC stored in the storage unit 30, and stores the read error information for each PLC in the storage unit 200.

The bus connecting unit 10 issues the signal 180 each time error information received by the receiving unit 40 from other PLCs is stored in the storage unit 30. Therefore, a user becomes capable of watching (i.e., monitoring) all bus errors caused on the bus 120 of the PLCs 300, 301 and 302 on a substantially real-time basis, regardless of to which CPU unit 110 the peripheral device 150 is connected in the PLCs 300, 301 and 302.

The time when the bus connecting unit 10 transfers the error information is not limited to a time when the error information received by the receiving unit 40 from other PLCs is stored in the storage unit 30. It is also possible that error information is transferred regularly, or that, for example, the peripheral device 150 issues an instruction to transfer the error information and the instruction is transferred at a time when the instruction is received via the CPU unit 110 and the bus 120.

Furthermore, while it has been described that the PLC 300, the PLC 301 and the PLC 302 perform communications in a token passing system, the communication system between PLCs is not limited to the token passing system.

As described above, the communication apparatus according to the first embodiment of the present invention is configured to include: the storage unit 30; the bus connecting unit 10 serving as a bus-error detecting unit that detects bus errors caused on a bus of its own PLC; the bus-error counting unit 20 that counts the number of times the bus connecting unit 10 has detected the bus error and records the counted value of the bus error as error information in the storage unit 30; the transmitting unit 50 that transmits the error information stored in the storage unit 30 to all of other PLCs belonging to the same PLC system 1; and the receiving unit 40 that receives the error information transmitted from the other PLCs that are connected to the same PLC system 1 and stores the received error information in the storage unit 30 in such a way that the PLC that is a transmission source can be identified. Therefore, only by checking an arbitrary one among the PLCs 300, 301 and 302 constituting the PLC system 1, a user can check bus errors caused in all of the PLCs 300 to 302, and thus the location where a bus error has occurred can be identified in a simpler manner than a case of checking every PLC.

### Second Embodiment

In the first embodiment, the network unit has a configuration of detecting and counting bus errors, but a function of detecting bus errors and a function of counting the number of bus error detections may be included in a functional unit other than the network unit.

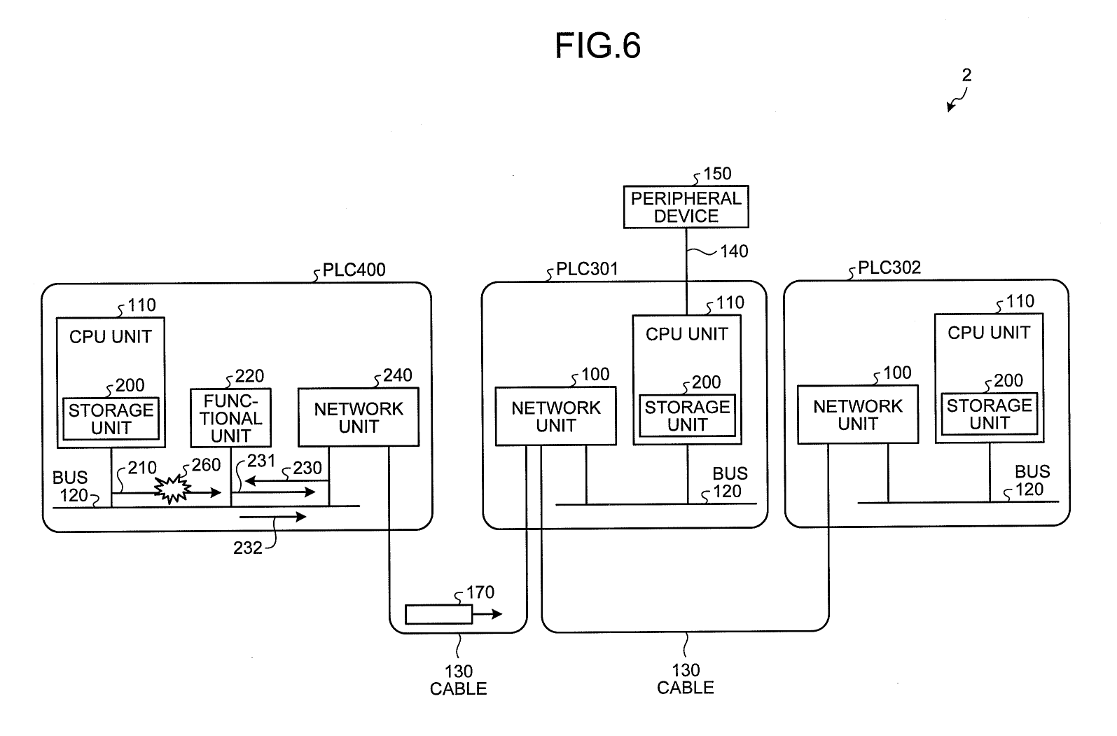

FIG. 6 is a diagram showing a configuration of a PLC system configured with a network unit to which a communication apparatus of a second embodiment of the present invention is applied. In the second embodiment, constituent elements equivalent to those in the first embodiment are denoted by the same reference signs and redundant descriptions thereof will be omitted.

As shown in FIG. 6, a PLC system 2 is constituted by a PLC 400, the PLC 301 and the PLC 302 that are connected to each other via the cable 130 in a daisy chain mode. The PLC 400 includes the CPU unit 110, a functional unit 220, a network unit 240, and the bus 120 that electrically connects these units.

The functional unit 220 may be any arbitrary unit excluding the network unit 240 and the CPU unit 110, and corresponds to an A/D converting unit, for example. The functional unit 220 is operated based on a control signal 210 transmitted from the CPU unit 110 via the bus 120.

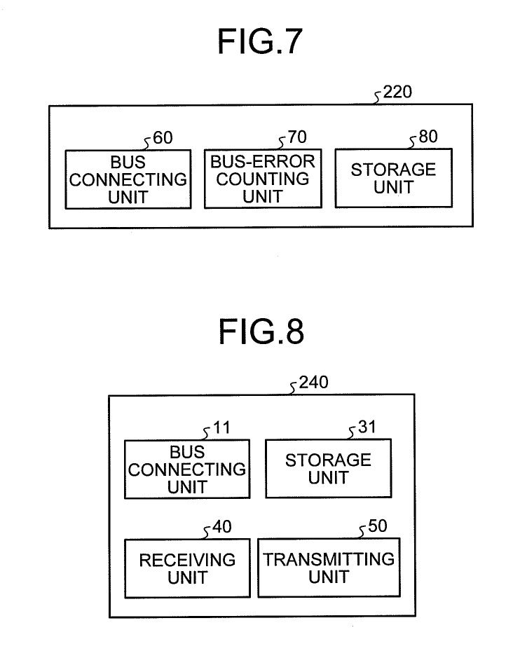

FIG. 7 is a diagram showing an internal configuration of the functional unit 220. In this example, description will be given only about functional constituent elements commonly used in functional units to which the second embodiment is applied.

As shown in FIG. 7, the functional unit 220 includes a bus connecting unit 60, a bus-error counting unit 70, and a storage unit 80. Upon reception of the control signal 210, the bus connecting unit 60 returns a reply to the CPU unit 110, and, when an error (that is, a bus error 260) is caused in transmitting the control signal 210, the bus connecting unit 60 can detect the caused bus error. The bus-error counting unit 70 counts the number of times the bus connecting unit 60 has detected a bus error and records the counted value as error information in the storage unit 80. A part or all of the bus connecting unit 60 and the bus-error counting unit 70 may be realized as either one of hardware and software, or as a combination thereof. The storage unit 80 is constituted by a rewritable storage device.

The network unit 240 acquires error information from the functional unit 220 and transmits the acquired error information to other PLCs. FIG. 8 is an explanatory diagram of an internal configuration of the network unit 240.

As shown in FIG. 8, the network unit 240 includes a bus connecting unit 11 that acquires error information from the functional unit 220, a storage unit 31 in which the error information acquired from the functional unit 220 is stored, the receiving unit 40, and the transmitting unit 50.

With reference to FIG. 6, an operation of the PLC system 2 according to the second embodiment is described next. Because an operation of a PLC at a side of receiving error information is identical to that in the first embodiment, only an operation of a PLC at a side of transmitting error information is described. In this example, the PLC 400 corresponds to a PLC at the side of transmitting error information.

As shown in FIG. 6, in the PLC 400, the bus connecting unit 11 included in the network unit 240 transmits a monitoring signal 230 for monitoring the presence of a bus error to the bus connecting unit 60 included in the functional unit 220 and receives a monitoring reply signal 231. In the functional unit 220, in the case where a bus error has been caused and the error information has been recorded in the storage unit 80, the bus connecting unit 60 adds the error information to the monitoring reply signal 231 and transmits the monitoring reply signal 231 to the bus connecting unit 11 included in the network unit 240.

In the network unit 240, upon reception of the monitoring reply signal 231, the bus connecting unit 11 reads the error information added to the received monitoring reply signal 231 and stores the read error information in the storage unit 31. The operation of the transmitting unit 50 to transmit the error information stored in the storage unit 31 to the PLC 301 is identical to that in the first embodiment.

It is also possible that the bus connecting unit 60 of the functional unit 220 actively transmits error information recorded in the storage unit 80 to the network unit 240 as a signal 232 including the error information.

As described above, according to the second embodiment of the present invention, the functional unit 220 is configured to include the bus connecting unit 60 serving as an error detecting unit that detects bus errors caused on the bus 120 and the bus-error counting unit 70 that counts the number of times the bus connecting unit 60 has detected a bus error, and the network unit 240 is configured to include the bus connecting unit 11 serving as a counted-value acquiring unit that acquires a counted value of bus errors from the functional unit 220 and records the acquired counted value as error information in the storage unit 31, the transmitting unit 50 that transmits the error information that is stored in the storage unit 30 and acquired from the functional unit 220, to all of other PLCs belonging to the same PLC system 2, and the receiving unit 40 that receives error information transmitted from the other PLCs belonging to the same PLC system 2 and stores the received error information in the storage unit 31 in such a way that the PLC that is a transmission source of the error information can be identified. Therefore, only by connecting the peripheral device 150 to an arbitrary one among the PLCs 400, 301, and 302 constituting the PLC system 2, a user can check a bus error caused in all of the PLCs 400, 301 and 302, and thus the location where a bus error has occurred can easily be identified.

### INDUSTRIAL APPLICABILITY

As described above, the communication apparatus according to the present invention is suitable to be applied to a network unit that is incorporated in a PLC and network-connects PLCs.

### REFERENCE SIGNS LIST

1, 2 PLC SYSTEM
10, 11, 60 BUS CONNECTING UNIT
20, 70 BUS-ERROR COUNTING UNIT
30, 31, 80, 200 STORAGE UNIT
40 RECEIVING UNIT
50 TRANSMITTING UNIT
100, 240 NETWORK UNIT
110 CPU UNIT
120 BUS
130, 140 CABLE
150 PERIPHERAL DEVICE
160 ACCESS ERROR
170 FRAME
180 SIGNAL
210 CONTROL SIGNAL
220 FUNCTIONAL UNIT
230 MONITORING SIGNAL
231 MONITORING REPLY SIGNAL

1. A communication apparatus that is connected to a bus, constitutes a programmable logic controller (PLC) together with the bus, and network-connects its own PLC to other PLCs, so as to establish a PLC system, the communication apparatus comprising:
a first storage unit;
an error detecting unit that detects a bus error caused on a bus of its own PLC;
an error counting unit that counts the number of times the error detecting unit has detected an bus error and records a counted value of a bus error in the first storage unit;
a transmitting unit that transmits a counted value that is recorded in the first storage unit, and counted by the error counting unit to all of other PLCs belonging to the same PLC system; and
a receiving unit that receives a counted value transmitted from the other PLCs belonging to the same PLC system and stores the received counted value in the first storage unit in such a way that a PLC that is a transmission source of the counted value can be identified.

2. The communication apparatus according to claim 1, wherein
a CPU unit including a second storage unit that can be referenced by a peripheral device is connected to the bus, and
the communication apparatus further comprises a bus connecting unit that transfers a counted value for each PLC stored in the first storage unit to the second storage unit via the bus.

3. The communication apparatus according to claim 2, wherein the bus connecting unit transfers a counted value for each PLC stored in the first storage unit to the second storage unit each time the receiving unit stores a counted value transmitted from the other PLCs in the first storage unit.

4. The communication apparatus according to claim 1, wherein the transmitting unit and the receiving unit perform communications to the other PLCs in compliance with a token passing system.

5. A communication apparatus that is connected to a bus, constitutes a programmable logic controller (PLC) together with the bus and with a functional unit connected to the bus, including an error detecting unit that detects a bus error caused on the bus and an error counting unit that counts the number of times the error detecting unit has detected a bus error, and network-connects its own PLC to other PLCs, so as to establish a PLC system, the communication apparatus comprising:
a first storage unit;
a counted-value acquiring unit that acquires a counted value of the error counting unit from the functional unit and records the acquired counted value in the first storage unit;
a transmitting unit that transmits a counted value recorded in the first storage unit to all of the other PLCs belonging to the same PLC system; and
a receiving unit that receives a counted value transmitted from the other PLCs belonging to the same PLC system and stores the received counted value in the first storage unit in such a way that a PLC that is a transmission source of the counted value can be identified.

6. The communication apparatus according to claim 5, wherein
a CPU unit including a second storage unit that can be referenced by a peripheral device is connected to the bus, and
the communication apparatus further comprises a bus connecting unit that transfers a counted value for each PLC stored in the first storage unit to the second storage unit via the bus.

7. The communication apparatus according to claim 6, wherein the bus connecting unit transfers a counted value for each PLC stored in the first storage unit to the second storage unit each time the receiving unit stores a counted value transmitted from the other PLCs in the first storage unit.

8. The communication apparatus according to claim 5, wherein the transmitting unit and the receiving unit perform communications to the other PLCs in compliance with a token passing system.
